(19) United States
(12) Patent Application Publication
(10) Pub. No.: US 2026/0341227 A1
(43) Pub. Date: Oct. 29, 2026

(54) Display Device

(71) Applicant: LG Display Co., Ltd., Seoul (KR)

(72) Inventor: ChangHeon Kang, Paju-si (KR)

(21) Appl. No.: 19/546,123

(22) Filed: Feb. 20, 2026

(30) Foreign Application Priority Data
Apr. 29, 2025 (KR) 10-2025-0056766

(51) Int. Cl. G09G 3/3266; G09G 3/3275; G09G 3/3233

(52) U.S. Cl. CPC G09G 3/3266; G09G 3/3275; G09G 3/3233; G09G 2300/0819; G09G 2300/0842; G09G 2330/021; G09G 2330/04

(57) ABSTRACT

Embodiments of the present disclosure are directed to the display device with a plurality of electrostatic discharge circuits. Each electrostatic discharge circuit includes the first transistor that is the P-type MOSFET and the second transistor that is the N-type MOSFET. The gate electrode of the first transistor, the source electrode of the first transistor, and the drain electrode of the second transistor are connected to each other.

### CROSS-REFERENCE TO RELATED APPLICATION

The present application claims priority to Republic of Korea Patent Application No. 10-2025-0056766, filed on Apr. 29, 2025, which is hereby incorporated by reference in its entirety.

### BACKGROUND

### Field

The present disclosure relates to a display apparatus and particularly to, for example, without limitation, a display device.

### Description of Related Art

The display device is applied to various electronic devices such as TVs, mobile phones, laptops, and tablets.

Various display devices, such as Organic Light Emitting Display (OLED) that emit light on their own, Liquid Crystal Display (LCD) that requires a separate light source, and a light emitting diode display including light emitting diodes (LED) are used in the display device.

Recently, in order to prevent damage to a display device due to static electricity, various antistatic circuits have been used. Specifically, static electricity may be generated by a process of manufacturing a display device. Alternatively, after the display device is manufactured, static electricity may be introduced into the display device from the outside.

Static electricity introduced into the display device may damage various devices in the display device. To solve this problem, by forming an electrostatic discharge circuit in the display device, static electricity introduced into the display device may be released, thereby protecting various devices inside the display device.

However, the electrostatic discharge circuit includes various elements. That is, there is a possibility that various elements included in the electrostatic discharge circuit may also be damaged by static electricity. If an element of the electrostatic discharge circuit is damaged, the electrostatic discharge circuit may not be driven normally.

In this case, static electricity introduced from the outside may not be released, the element in the display device may be damaged by static electricity, and the display device may not be driven normally. Alternatively, even if static electricity introduced from the outside is released, the display device may not be driven smoothly by the damaged electrostatic d ischarge circuit.

### SUMMARY

The present disclosure has been made in view of the above problems and other limitations associated with the related art.

Accordingly, it is an aspect of the present disclosure to provide a display device including an electrostatic discharge circuit. Specifically, it is an aspect of the present disclosure to provide a display device including an electrostatic discharge circuit that is prevented from being damaged by static electricity.

In accordance with one or more embodiments of the present disclosure, the above and other technical effects can be accomplished by the provision of a display device comprising a display panel that includes a plurality of pixels and an electrostatic discharge circuit unit, and a plurality of electrostatic discharge circuits disposed in the electrostatic discharge circuit unit, wherein each of the plurality of electrostatic discharge circuits includes a first transistor and a second transistor, wherein the first transistor is a P-type MOSFET, the second transistor is an N-type MOSFET, wherein each of the first transistor and the second transistor includes a gate electrode, a source electrode, and a drain electrode, and wherein the gate electrode of the first transistor, the source electrode of the first transistor, and the drain electrode of the second transistor are electrically connected to each other.

In accordance with one or more other embodiments of the present disclosure, the above and other technical effects can be accomplished by the provision of a display device comprising a display panel including a plurality of pixels and an electrostatic discharge circuit, a gate driver generating, using a power voltage, a scan signal applied to a pixel of the plurality of pixels for scanning the pixel, a power line through which the power voltage is supplied to the electrostatic discharge circuit, and a signal line through which a first signal for driving the pixel is applied to the pixel or through which a second signal for controlling the gate driver is applied to the gate driver. The electrostatic d ischarge circuit includes a first transistor of a first type that is turned on in response to a first logic signal (e.g., p-type MOSFET) and a second transistor of a second type that is turned on in response to a second logic signal opposite to the first logic signal (e.g., n-type MOSFET). A gate electrode of the first transistor, a source electrode of the first transistor, and a drain electrode of the second transistor are electrically connected to the signal line. A drain electrode of the first transistor, a gate electrode of the second transistor, and a source electrode of the second transistor are electrically connected to the power line.

It is to be understood that both the foregoing general description and the following detailed description are examples and explanatory and are intended to provide further explanation of the inventive concepts as claimed.

### BRIEF DESCRIPTION OF THE DRAWINGS

The accompanying drawings, which are included to provide a further understanding of the present disclosure and are incorporated in and constitute a part of this application, illustrate embodiments of the present disclosure and together with the description explain the principle of the disclosure. In the drawings:

FIG. 1 is a schematic perspective view of a display device according to one or more embodiments of the present disclosure.

FIG. 2 is a circuit diagram of one pixel according to one or more embodiments of the present disclosure.

FIG. 3 is a circuit diagram of an electrostatic discharge circuit according to a conventional embodiment.

FIG. 4 is a circuit diagram illustrating a case in which static electricity is introduced into the electrostatic discharge circuit according to FIG. 3.

FIG. 5 is a cross-sectional view of a first transistor of the electrostatic discharge circuit according to FIG. 3.

FIG. 6 is a cross-sectional view of a second transistor of the electrostatic discharge circuit according to FIG. 3.

FIG. 7 is a circuit diagram of an electrostatic discharge circuit according to one or more embodiments of the present disclosure.

FIG. 8 is a circuit diagram illustrating a case in which static electricity is introduced into the electrostatic discharge circuit according to FIG. 7.

FIG. 9 is a cross-sectional view of a fourth transistor of the electrostatic discharge circuit according to one or more embodiments of the present disclosure.

FIG. 10 is a circuit diagram of an electrostatic discharge circuit according to one or more other embodiments of the present disclosure.

Throughout the drawings and the detailed description, unless otherwise described, the same drawing reference numerals should be understood to refer to the same elements, features, and structures. The relative size and depiction of these elements can be exaggerated for clarity, illustration, and convenience.

### DETAILED DESCRIPTION

Reference will now be made in detail to embodiments of the present disclosure, examples of which can be illustrated in the accompanying drawings. The progression of processing steps and/or operations described is an example; however, the sequence of steps and/or operations is not limited to that set forth herein and can be changed as is known in the art, with the exception of steps and/or operations necessarily occurring in a particular order. Names of the respective elements used in the following explanations can be selected only for convenience of writing the specification and can be thus different from those used in actual products.

Advantages and features of the present disclosure, and implementation methods thereof, will be clarified through the following examples described with reference to the accompanying drawings. The present disclosure may, however, be embodied in different forms and should not be construed as limited to the examples set forth herein. Rather, these examples are provided so that the specification of the present disclosure will be thorough, complete, and fully convey the scope of the present disclosure to those skilled in the art.

A shape, a size, a ratio, an angle, and a number disclosed in the accompanying drawings for describing the examples of the present disclosure are merely illustrative and, thus, the present disclosure is not limited to the illustrated details. Unless stated otherwise, like reference numerals refer to like elements throughout the disclosure. In the following description, when the detailed description of the relevant known function or configuration is determined to unnecessarily obscure an important point of the present disclosure, the detailed description will be omitted. In a case where terms such as ‘comprise’, ‘have’, and ‘include’ described in the present disclosure are used, another portion can be added unless ‘only’ is used. The terms of a singular form can include plural forms unless referred to the contrary.

In interpreting the components, it is interpreted as including an error range even if there is no separate explicit description of an error range.

In describing a position relationship, for example, when the position relationship is described using terms such as ‘upon’, ‘above’, ‘below’ and ‘next to’, one or more portions can be disposed between two other portions unless ‘just’ or ‘direct’ is used. The terms, such as “below,” “lower,” “above,” “upper”, and the like, can be used herein to describe a relationship between elements as illustrated in the drawings. It will be understood that the terms are spatially relative and based on the orientation depicted in the drawings.

A description of a time relationship can include a case in which the temporal precedence relationship is described as “after”, “following”, or “before”, etc., and is not continuous unless “right away” or “directly”, is used.

Although the terms such as first, second, and the like are used to describe various components, these components are not limited by these terms. These terms are used only to distinguish one component from another. Therefore, a first component mentioned below can be a second component within a technical idea of a present disclosure.

It will be understood that, although the terms such as “first,” “second,” “A,” “B,” “(a),” and “(b)”, etc., can be used herein to describe various elements, these elements should not be limited by these terms. These terms are only used to distinguish one element from another. For example, a first element could be termed a second element, and, similarly, a second element could be termed a first element, without departing from the scope of the present disclosure. Further, the term “can” fully encompasses all the meanings and coverages of the term “may” and vice versa.

Features of each of the various examples of the present disclosure can be partially or entirely coupled or combined with each other, technically various interworking and driving are possible, and each of the examples can be independently implemented with respect to each other or can be implemented together in a related relationship.

Hereinafter, embodiments of the present disclosure will be described in detail with reference to the accompanying drawings. All the components of each display device/apparatus according to all embodiments of the present disclosure are operatively coupled and configured.

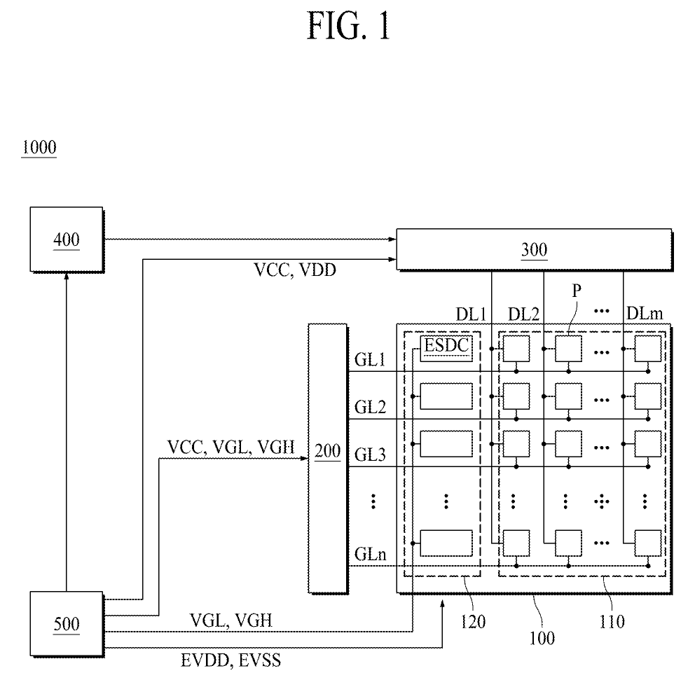

FIG. 1 is a schematic perspective view of a display device 1000 according to one or more embodiments of the present disclosure.

The display device 1000 may include a display panel 100, a gate driver 200, a data driver 300, a timing controller 400, and a power supply unit 500.

Hereinafter, a case where the display device 1000 according to the present disclosure is an organic light emitting display device will be described. However, the present disclosure is not limited thereto. For example, the display device according to the present disclosure may be a display device other than the organic light emitting display device.

The display panel 100 may include a display area for displaying an image and a non-display area disposed outside the display area. The non-display area may surround the display area, but is not limited thereto.

A plurality of gate lines GL1 to GLn (where n is a natural number greater than 1) and a plurality of data lines DL1 to DLm (where m is a natural number greater than 1) may be disposed in the display area. The plurality of gate lines GL and the plurality of data lines DL may intersect with each other.

The display panel 100 may include a pixel unit 110 and an electrostatic discharge circuit unit 120. The pixel unit 110 may be disposed in the display area, and the electrostatic discharge circuit unit 120 may be disposed in the non-display area. The pixel unit 110 may extend from the display area and may also be disposed in a portion of the non-display area, but is not limited thereto.

FIG. 1 shows that the electrostatic discharge circuit unit 120 is disposed at one side of the pixel unit 110, but is not limited thereto. For example, the electrostatic discharge circuit unit 120 may be disposed at the other side of the pixel unit 110. Alternatively, the electrostatic discharge circuit unit 120 may be disposed at an upper side or a lower side of the pixel unit 110.

The pixel unit 110 may include a plurality of pixels P. The plurality of pixels P may be disposed in a region where the plurality of gate lines GL and the plurality of data lines DL intersect with each other. That is, the plurality of pixels P may be arranged in a matrix form including a plurality of rows and a plurality of columns.

Each of the plurality of pixels P may receive a scan signal through the plurality of gate lines GL. In addition, each of the plurality of pixels P may receive a data signal through the plurality of data lines DL.

The electrostatic discharge circuit unit 120 may include a plurality of electrostatic discharge circuits ESDC. The plurality of electrostatic discharge circuits ESDC may release static electricity introduced into the display panel 100 to protect the display panel 100 from static electricity.

The gate driver 200 may receive a gate driver control signal from the timing controller 400. The gate driver 200 may supply a scan signal to the gate line GL according to the gate driver control signal.

The gate driver 200 may be disposed in the non-display area at one or both sides of the display area of the display panel 100 by a GIP (gate driver in panel) method, but is not limited thereto.

The data driver 300 may receive a data driver control signal and an image data from the timing controller 400. The data driver 300 may convert an image data into a data voltage according to the data driver control signal. In addition, the data driver 300 may supply the converted data voltage to the data line DL.

The timing controller 400 may control operation timings of the gate driver 200 and the data driver 300. The timing controller 400 may generate a gate driver control signal, a data driver control signal, and an image data according to a timing signal supplied from the host system.

The timing controller 400 may supply the gate driver control signal to the gate driver 200.

The gate driver control signal may include a gate start signal and a gate clock signal. The gate start signal may be a signal that controls an output timing of a first scan signal of the gate driver 200. In addition, the gate clock signal may be a signal for shifting the gate start signal. In addition, the gate driver control signal may further include various signals for controlling the gate driver.

The timing controller 400 may supply the data driver control signal and the image data to the data driver 300.

The power supply unit 500 may generate various voltages required in a driving process of each of the display panel 100, the gate driver 200, the data driver 300, and the timing controller 400. Furthermore, the power supply unit 500 may supply the generated various voltages to each of the display panel 100, the gate driver 200, the data driver 300, and the timing controller 400.

The power supply unit 500 may supply a high potential voltage EVDD and a low potential voltage EVSS to the plurality of pixels P of the display panel 100. The high potential voltage EVDD and the low potential voltage EVSS may be voltages for driving the plurality of pixels P.

The power supply unit 500 may supply a gate power voltage VCC, a gate high voltage VGH, and a gate low voltage VGL to the gate driver 200.

The gate power supply voltage VCC may be a voltage for driving the gate driver 200. In addition , the gate high voltage VGH and the gate low voltage VGL may set a scan signal of the gate driver 200. Specifically, the scan signal generated by the gate driver 200 may be output as a voltage having a positive gate high voltage VGH and a negative gate low voltage VGL.

The power supply unit 500 may supply a data power supply voltage VCC and a data driving voltage VDD to the data driver 300.

The data power supply voltage VCC may be a voltage for driving the data driver 300. In addition, the data voltage of the data driver 300 may be set by the data driving voltage VDD. Specifically, the data driver 300 may receive the image data from the timing controller 400 and generate the data voltage in response to the data driving voltage VDD.

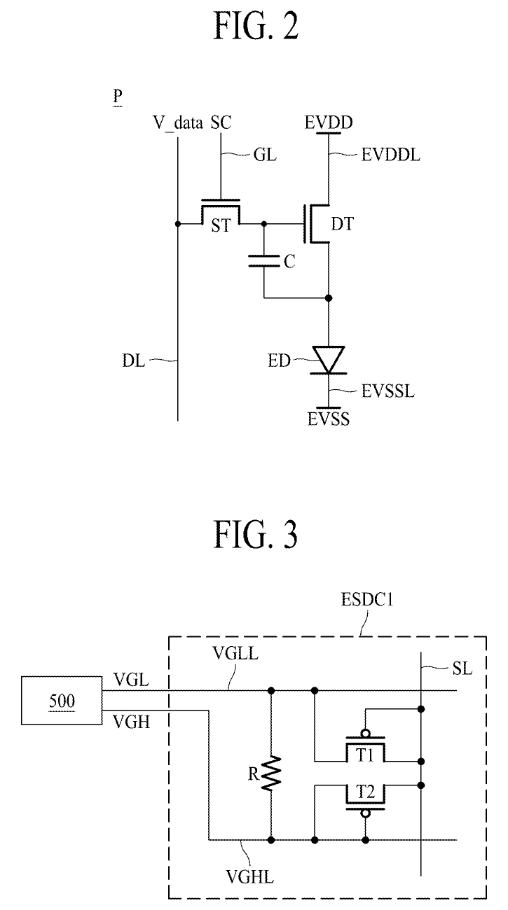

FIG. 2 is a circuit diagram of one pixel according to one or more embodiments of the present disclosure.

Referring to FIG. 2, one pixel P may include a driving transistor DT, a switching transistor ST, a capacitor C, and a light emitting device ED. The driving transistor DT, the switching transistor ST, and the capacitor C may be configured to drive the light emitting device ED.

The driving transistor DT may be disposed between a high potential voltage line EVDDL and the light emitting device ED. The driving transistor DT may adjust a driving current. Specifically, the driving transistor DT may adjust a current flowing from the high potential voltage line EVDDL to the light emitting device ED according to a voltage difference between a gate electrode and a source electrode of the driving transistor DT.

A gate electrode of the driving transistor DT may be connected to a first electrode of the switching transistor ST, a first electrode (source electrode or drain electrode) may be connected to an anode of the light emitting device ED, and the second electrode (drain electrode or source electrode) may be connected to the high potential voltage line EVDDL to which the high potential voltage EVDD is supplied.

The switching transistor ST may be driven by a scan signal SC of the gate line GL. When the switching transistor ST is turned on by the scan signal SC, the switching transistor ST may supply the data voltage V_data of the data line DL to the gate electrode of the driving transistor DT.

A gate electrode of the switching transistor ST may be connected to the gate line GL, a first electrode may be connected to the gate electrode of the driving transistor DT, and a second electrode may be connected to the data line DL.

The capacitor C may be disposed between the gate electrode and the source electrode of the driving transistor DT. The capacitor C may store a difference voltage between the gate voltage and the source voltage of the driving transistor DT.

FIG. 2 illustrates that the driving transistor DT and the switching transistor ST are formed of an N-type metal oxide semiconductor field effect transistor (MOSFET), but are not limited thereto. For example, the driving transistor DT and the switching transistor ST may be P-type MOSFET.

In addition, the first electrode may be a source electrode, and the second electrode may be a drain electrode, but is not limited thereto. For example, the first electrode may be a drain electrode, and the second electrode may be a source electrode.

The light emitting device ED may emit light according to a current supplied through the driving transistor DT. An anode of the light emitting device ED may be connected to the source electrode of the driving transistor DT, and a cathode of the light emitting device ED may be connected to a low potential voltage line EVSSL to which a low potential voltage EVSS is supplied. The low potential voltage EVSS may be a voltage lower than the high potential voltage EVDD.

When the light emitting device ED is an organic light emitting diode (OLED), the light emitting device ED may include an anode, a hole transport layer, an emission layer, an electron transport layer, and a cathode.

When a voltage is applied to the anode and the cathode by the driving transistor DT, the switching transistor ST, and the capacitor C, holes and electrons are moved to the emission layer through the hole transport layer and the electron transport layer, respectively, and holes and electrons may be coupled to each other in the emission layer. Accordingly, the light emitting device ED may emit light.

FIG. 2 discloses that one pixel P includes two transistors and one capacitor, but is not limited thereto. For example, the pixel P may include three or more transistors or two or more capacitors.

Alternatively, each of the plurality of pixels P may be further connected to a wiring other than the high potential voltage line EVDDL, the low potential voltage line EVSSL, the gate line GL, and the data line DL to further receive a voltage other than the high potential voltage EVDD, the low potential voltage EVSS, the scan signal SC, and the data voltage V_data.

For example, the power supply unit 500 may supply an initialization voltage to the plurality of pixels P, and each of the plurality of pixels P may further include an initialization voltage line. In this case, each of the plurality of pixels P receives an initialization voltage through the initialization voltage line, and a specific electrode of the driving transistor DT or the switching transistor ST may be initialized to a specific voltage.

FIG. 3 is a circuit diagram of an electrostatic discharge circuit ESDC1 according to a conventional embodiment.

Referring to FIG. 3, the electrostatic discharge circuit ESDC1 may include a first transistor T1, a second transistor T2, and a resistor R.

The first transistor T1 and the second transistor T2 may be the same type of MOSFET. FIG. 3 illustrates that the first transistor T1 and the second transistor T2 are P-type MOSFETs, but the present disclosure is not limited thereto.

A gate electrode of the first transistor T1 and a source electrode of the first transistor T1 may be connected to a signal line SL, and a drain electrode of the first transistor T1 may be connected to a gate low voltage line VGLL. The gate low voltage line VGLL may be a wiring to which a gate low voltage VGL is supplied from the power supply unit 500.

A gate electrode of the second transistor T2 and a drain electrode of the second transistor T2 may be connected to a gate high voltage line VGHL, and a source electrode of the second transistor T2 may be connected to the signal line SL. The gate high voltage line VGHL may be a wiring to which a gate high voltage VGH is supplied from the power supply unit 500.

The gate electrode of the first transistor T1, the source electrode of the first transistor T1, and the source electrode of the second transistor T2 may be connected to the same node through the signal line SL.

The signal line SL may be any one of various wirings for applying a signal to the pixel P of the display panel 100.

For example, the signal line SL may be a data line DL for applying a data voltage to the pixel P or a wiring branched from the data line DL.

Alternatively, the signal line SL may be any one of various wirings for applying a signal to the gate driver 200.

For example, the signal line SL may be a gate start signal line for applying a gate start signal to the gate driver 200 or a wiring branched from the gate start signal line. Alternatively, the signal line SL may be a gate clock signal line for applying a gate clock signal to the gate driver 200 or a wiring branched from the gate clock signal line.

The resistor R may be connected between the gate low voltage line VGLL and the gate high voltage line VGHL. That is, the resistor R may be connected between the drain electrode of the first transistor T1 and the drain electrode of the second transistor T2.

When a static electricity having a high-voltage flows into the electrostatic discharge circuit ESDC1, the resistance R may make the gate low voltage line VGLL and the gate high voltage line VGHL relatively equal to each other compared to the static electricity having the high-voltage. The resistance R may be several MΩ to several hundred MΩ, but is not limited thereto.

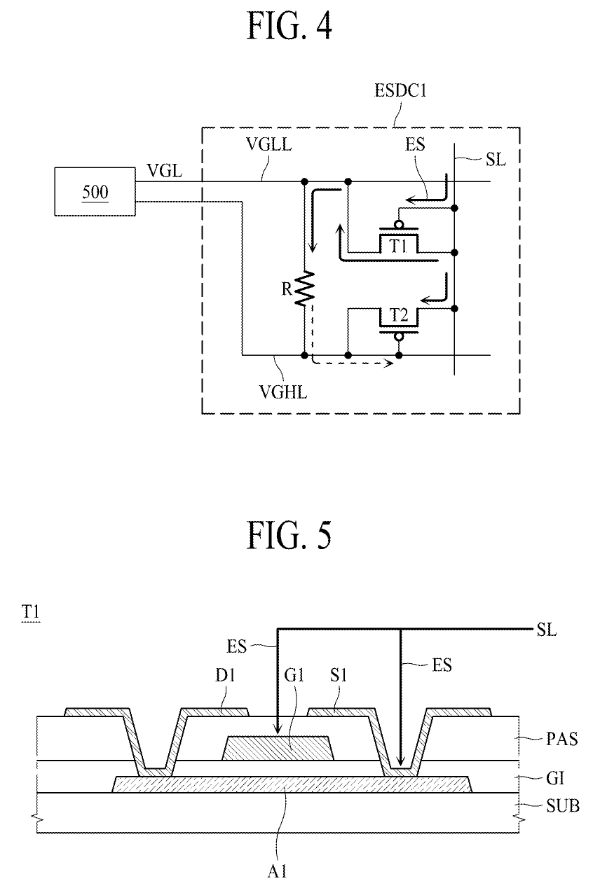

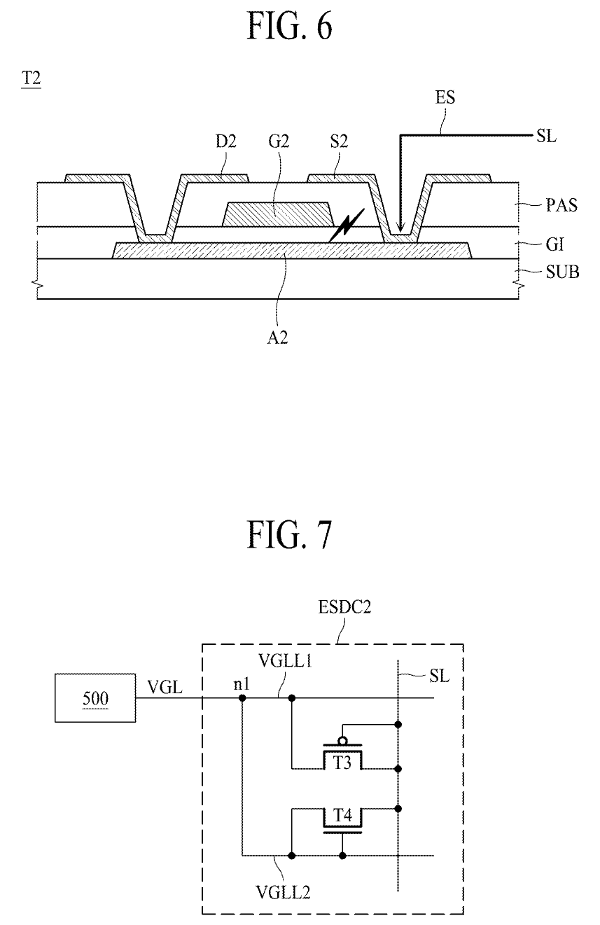

FIG. 4 is a circuit diagram illustrating a case in which static electricity ES is introduced into the electrostatic discharge circuit ESDC1 according to FIG. 3. And, FIG. 5 is a cross-sectional view of the first transistor T1 of the electrostatic discharge circuit ESDC1 according to FIG. 3. And, FIG. 6 is a cross-sectional view of the second transistor T2 of the electrostatic discharge circuit ESDC1 according to FIG. 3.

Referring to FIG. 4, a static electricity ES may be introduced into the electrostatic discharge circuit ESDC1. The static electricity ES may be generated by a manufacturing process of the display device 1000. Alternatively, after the display device 1000 is manufactured, the static electricity ES may be introduced into the display device 1000 from the outside.

The static electricity ES may be introduced into the electrostatic discharge circuit ESDC1 through the signal line SL. When the static electricity ES is applied to the signal line SL, the gate electrode of the first transistor T1 and the source electrode of the first transistor T1 are connected to the signal line SL, and thus the static electricity ES may be quickly applied to the gate electrode of the first transistor T1 and the source electrode of the first transistor T1 through the signal line SL.

In this case, referring to FIG. 5, the first transistor T1 may include a gate electrode G1, an active layer A1, a source electrode S1, and a drain electrode D1.

The active layer A1 may be disposed on the substrate SUB. The active layer A1 may include at least one oxide of indium-gallium-zinc-oxide (IGZO), indium-zinc-oxide (IZO), indium-gallium-tin-oxide (IGO), and indium-gallium-oxide (IGO), but is not limited thereto.

The gate electrode G1 may be disposed on the active layer A1. The gate electrode G1 may include a metal material such as Au, W, Pt, Si, Ir, Ag, Cu, Ni, Ti, or Cr, but is not limited thereto.

The gate insulating layer GI may be disposed between the gate electrode G1 and the active layer A1 to insulate the gate electrode G1 and the active layer A1. The gate insulating layer GI may be formed of a single layer of silicon nitride (SiNx) or silicon oxide (SiOx), or multiple layers thereof, but is not limited thereto.

The source electrode S1 and the drain electrode D1 may be disposed on the active layer A1 while facing each other.

A passivation layer PAS is disposed between the source electrode S1 and the gate electrode G1 and between the drain electrode D1 and the gate electrode G1, and may insulate the source electrode S1 and the drain electrode D1 from the gate electrode G1. In addition, each of the source electrode S1 and the drain electrode D1 may be in contact with and electrically connected to the active layer A1 through a contact hole disposed in the gate insulating layer GI and the passivation layer PAS.

As described in FIG. 4, the static electricity ES applied by the signal line SL may be rapidly applied to the gate electrode G1 of the first transistor T1 and the source electrode S1 of the first transistor T1. Accordingly, the same charge may be introduced into the gate electrode G1 of the first transistor T1 and the source electrode S1 of the first transistor T1.

That is, the same charge may be applied to the gate electrode G1 disposed at an upper portion of the gate insulating layer GI and the active layer A1 disposed at a lower portion of the gate insulating layer GI. Therefore, the gate electrode G1 disposed at the upper portion of the gate insulating layer GI and the active layer A1 disposed at the lower portion of the gate insulating layer GI may not be electrically charged. Therefore, the first transistor T1 may normally discharge the static electricity ES.

Meanwhile, when the static electricity ES is applied to the signal line SL, since the source electrode S2 of the second transistor T2 is connected to the signal line SL, the static electricity ES may be quickly applied to the source electrode S2 of the second transistor T2.

However, compared to the source electrode S2 of the second transistor T2, static electricity ES may be applied relatively slowly to the gate electrode G2 of the second transistor T2 and the drain electrode D2 of the second transistor T2.

The static electricity ES applied to the signal line SL may be applied as the resistor R through the source electrode S1 of the first transistor T1 and the drain electrode D1 of the first transistor T1. Accordingly, the static electricity ES is not immediately applied to the gate electrode G2 of the second transistor T2 and the drain electrode D2 of the second transistor T2. Specifically, after the static electricity ES passes through the resistor R, the static electricity ES may be applied to the gate electrode G2 of the second transistor T2 and the drain electrode D2 of the second transistor T2.

That is, as the static electricity ES passes through the resistor R, a time during which the static electricity ES is transferred to the gate electrode G2 of the second transistor T2 and the drain electrode D2 of the second transistor T2 may be delayed. Accordingly, the static electricity ES may be applied relatively slowly to the gate electrode G2 of the second transistor T2 and the drain electrode D2 of the second transistor T2, compared to the source electrode S2 of the second transistor T2.

In this case, for a short time, the static electricity ES is instantaneously applied to the source electrode S2 of the second transistor T2, but the static electricity ES is not applied to the gate electrode G2 of the second transistor T2, and the gate electrode G2 of the second transistor T2 may be in a floating state.

In this case, referring to FIG. 6, like the first transistor T1, the second transistor T2 may include a gate electrode G2, an active layer A2, a source electrode S2, and a drain electrode D2.

As described in FIG. 4, the static electricity ES applied by the signal line SL may be rapidly applied to the source electrode S2 of the second transistor T2. However, the static electricity ES may be applied relatively slowly to the gate electrode G2 of the second transistor T2 and the drain electrode D2 of the second transistor T2. Therefore, for a short time, the static electricity ES is instantaneously applied to the source electrode S2 of the second transistor T2, but the gate electrode G2 of the second transistor T2 may be in the floating state.

Accordingly, for a short time, electric charges may be introduced into the source electrode S2 of the second transistor T2, but electric charges may not be introduced into the gate electrode G2 of the second transistor T2.

That is, in the second transistor T2, a large difference in charge may occur between the gate electrode G2 disposed at the upper portion of the gate insulating layer GI and the active layer A2 disposed at the lower portion of the gate insulating layer GI. Since different charges are applied to the gate electrode G2 disposed at the upper portion of the gate insulating layer GI and the active layer A2 disposed at the lower portion of the gate insulating layer GI, the gate electrode G2 disposed at the upper portion and the active layer A2 disposed at the lower portion may be electrically charged.

For a short time, the static electricity ES having the high-voltage is instantaneously applied to the second transistor T2, the gate insulating layer GI may be destroyed, and the gate insulating layer GI may not perform the insulating function normally. That is, the second transistor T2 may not be driven normally.

In this case, the gate insulating layer GI disposed in the second transistor T2 is destroyed, and the second transistor T2 may be deteriorated. Accordingly, the second transistor T2 may not normally discharge the static electricity ES, and there may be a problem that the electrostatic discharge circuit ESDC1 is not normally driven.

In addition, when the display device 1000 is driven, a change may occur in a threshold voltage of the second transistor T2 due to the broken gate insulating layer GI. Accordingly, an excessive current may flow in a channel region of the second transistor T2, and a thermal damage may occur due to the excessive current.

The thermal damage may affect a wiring connected to the second transistor T2. For example, the gate low voltage line VGLL or the gate high voltage line VGHL may be affected, but the present disclosure is not limited thereto.

Meanwhile, the resistor R is connected between the gate low voltage line VGLL and the gate high voltage line VGHL. When the display device 1000 is driven, the resistor R connected between the gate low voltage line VGLL and the gate high voltage line VGHL may be used as a path through which a leakage current flows. Accordingly, power consumption of the display device 1000 may be reduced.

To solve this problem, the present disclosure discloses an electrostatic discharge circuit ESDC2 illustrated in FIG. 7.

Referring to FIG. 7, the electrostatic discharge circuit ESDC2 may include a third transistor T3 and a fourth transistor T4.

The third transistor T3 and the fourth transistor T4 may be different types of MOSFETs. The third transistor T3 may be a P-type MOSFET, and the fourth transistor T4 may be an N-type MOSFET.

A gate electrode of the third transistor T3 and a source electrode of the third transistor T3 may be connected to the signal line SL, and a drain electrode of the third transistor T3 may be connected to a first gate low voltage line VGLL1. The first gate low voltage line VGLL1 may be a wiring to which the gate low voltage VGL is supplied from the power supply unit 500.

A gate electrode of the fourth transistor T4 and a source electrode of the fourth transistor T4 may be connected to a second gate low voltage line VGLL2, and a drain electrode of the fourth transistor T4 may be connected to the signal line SL. The second gate low voltage line VGLL2 may be a wiring branched from a first node n1 of the first gate low voltage line VGLL1. That is, the first gate low voltage line VGLL1 and the second gate low voltage line VGLL2 may be connected to the same node.

The gate electrode of the third transistor T3, the source electrode of the third transistor T3, and the drain electrode of the fourth transistor T4 may be electrically connected to each other. In addition, the gate electrode of the third transistor T3, the source electrode of the third transistor T3, and the drain electrode of the fourth transistor T4 may be connected to the same node through the signal line SL.

The drain electrode of the third transistor T3, the gate electrode of the fourth transistor T4, and the source electrode of the fourth transistor T4 may be electrically connected to each other. In addition, as described above, since the second gate low voltage line VGLL2 is a wiring branched from the first node n1 of the first gate low voltage line VGLL1, the drain electrode of the third transistor T3, the gate electrode of the fourth transistor T4, and the source electrode of the fourth transistor T4 may be connected to the same node through the first gate low voltage line VGLL1 and the second gate low voltage line VGLL2.

The signal line SL may be any one of various wirings for applying a signal to the pixel P of the display panel 100. For example, the signal line SL may be a data line DL for applying a data voltage to the pixel P or a wiring branched from the data line DL.

Alternatively, the signal line SL may be any one of various wirings for applying a signal to the gate driver 200. For example, the signal line SL may be a gate start signal line for applying a gate start signal to the gate driver 200 or a wiring branched from the gate start signal line. Alternatively, the signal line SL may be a gate clock signal line for applying a gate clock signal to the gate driver 200 or a wiring branched from the gate clock signal line.

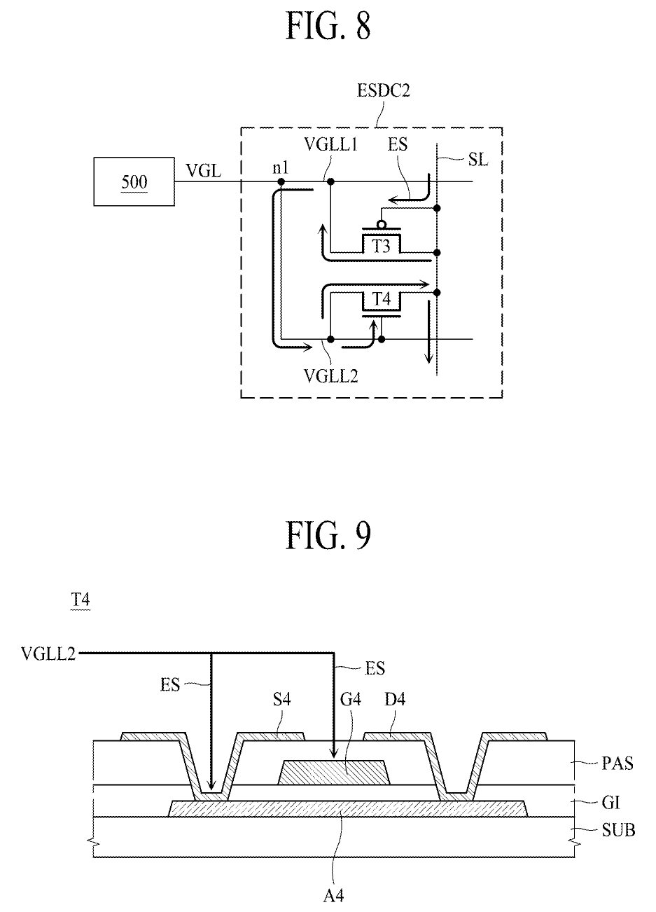

FIG. 8 is a circuit diagram illustrating a case in which static electricity ES is introduced into the electrostatic discharge circuit ESDC2 according to FIG. 7. And, FIG. 9 is a cross-sectional view of the fourth transistor T4 of the electrostatic discharge circuit ESDC2 according to FIG. 7.

Referring to FIG. 8, the static electricity ES may be introduced into the electrostatic discharge circuit ESDC2. The static electricity ES may be applied to the electrostatic discharge circuit ESDC2 through the signal line SL. When the static electricity ES is applied to the signal line SL, since the gate electrode of the third transistor T3 and the source electrode of the third transistor T3 are connected to the signal line SL, the static electricity ES may be quickly applied to the gate electrode of the third transistor T3 and the source electrode of the third transistor T3 through the signal line SL.

Like the first transistor T1 described in FIG. 5, the third transistor T3 may include a gate electrode G3, an active layer A3, a source electrode S3, and a drain electrode D3. In addition, a gate insulating layer GI may be disposed between the gate electrode G3 and the active layer A3 to insulate the gate electrode G3 and the active layer A3.

As described above in FIG. 5, the static electricity ES applied by the signal line SL may be rapidly applied to the gate electrode G3 of the third transistor T3 and the source electrode S3 of the third transistor T3. Accordingly, the same electric charge may be introduced into the gate electrode G3 of the third transistor T3 and the source electrode S3 of the third transistor T3.

That is, the same electric charge may be applied to the gate electrode G3 disposed at the upper portion of the gate insulating layer GI and the active layer A3 disposed at the lower portion of the gate insulating layer GI. Accordingly, the gate electrode G3 disposed at the upper portion of the gate insulating layer GI and the active layer A3 disposed at the lower portion of the gate insulating layer GI may not be electrically charged. Therefore, the third transistor T3 may normally discharge the static electricity ES.

Meanwhile, when the static electricity ES is applied to the signal line SL, the drain electrode of the fourth transistor T4 is connected to the signal line SL, so that the static electricity ES may be quickly applied to the source electrode of the fourth transistor T4.

Since the gate electrode of the fourth transistor T4 and the source electrode of the fourth transistor T4 are connected to the second gate low voltage line VGLL2 branched from the first node n1 of the first gate low voltage line VGLL1, the static electricity ES may be quickly applied to the gate electrode of the fourth transistor T4.

In this case, referring to FIG. 9, like the first transistor T1, the fourth transistor T4 may include a gate electrode G4, an active layer A4, a source electrode S4, and a drain electrode D4. The gate insulating layer GI may be disposed between the gate electrode G4 and the active layer A4 to insulate the gate electrode G4 and the active layer A4.

As described above in FIG. 7, the static electricity ES transferred by the second gate low voltage line VGLL2 may be quickly applied to the gate electrode G4 of the fourth transistor T4 and the source electrode S4 of the fourth transistor T4. Accordingly, the same electric charge may be introduced into the gate electrode G4 of the fourth transistor T4 and the source electrode S4 of the fourth transistor T4.

That is, the same electric charge may be applied to the gate electrode G4 disposed at the upper portion of the gate insulating layer GI and the active layer A4 disposed at the lower portion of the gate insulating layer GI. Accordingly, the gate electrode G4 disposed at the upper portion of the gate insulating layer GI and the active layer A4 disposed at the lower portion of the gate insulating layer GI may not be electrically charged. Therefore, the fourth transistor T4 may normally discharge the static electricity ES.

In conclusion, compared to the conventional electrostatic discharge circuit ESDC1 disclosed in FIG. 3, the electrostatic discharge circuit ESDC2 of the present disclosure disclosed in FIG. 7 can stably discharge the static electricity ES by preventing damage to the elements inside the electrostatic discharge circuit ESDC2 due to instantaneous static electricity ES.

Specifically, the electrostatic discharge circuit ESDC1 disclosed in FIG. 3 uses the same type of transistor, but the electrostatic discharge circuit ESDC2 of the present disclosure uses different types of transistors. Specifically, the electrostatic discharge circuit ESDC2 of the present disclosure uses the third transistor T3 which is a P-type MOSFET and the fourth transistor T4 which is an N-type MOSFET.

Accordingly, the electrostatic discharge circuit ESDC1 disclosed in FIG. 3 uses the gate low voltage line VGLL and the gate high voltage line VGHL, which are wires that apply different voltages from each other, but the electrostatic discharge circuit ESDC2 of the present disclosure may use only the gate low voltage line VGLL. Therefore, the wiring for the electrostatic discharge circuit ESDC2 may be further simplified.

In addition, as described above, the conventional electrostatic discharge circuit ESDC1 disclosed in FIG. 3 discloses the resistance R to make the gate low voltage line VGLL and the gate high voltage line VGHL relatively equal when a static electricity ES having a high-voltage is introduced. However, since the electrostatic discharge circuit ESDC2 of the present disclosure uses only the gate low voltage line VGLL, the resistance R of the conventional electrostatic discharge circuit ESDC1 disclosed in FIG. 3 may be omitted.

The electrostatic discharge circuit ESDC2 of the present disclosure may prevent an instantaneous transfer delay problem of the static electricity ES due to the resistance R occurring in the conventional electrostatic discharge circuit ESDC1 disclosed in FIG. 3 by omitting the configuration of the resistor R. That is, it is possible to prevent the gate electrode G4 of the fourth transistor T4 from being instantaneously floated for a short time.

Accordingly, the present disclosure may prevent the destruction of the gate insulating layer GI and the deterioration of the fourth transistor T4. Accordingly, the electrostatic discharge circuit ESDC2 of the present disclosure may prevent damage caused by the instantaneous static electricity ES, and the electrostatic discharge circuit ESDC2 may be stably driven.

In addition, when the display device 1000 is driven, the resistor R of the conventional electrostatic discharge circuit ESDC1 shown in FIG. 3 may be used as a path through which a leakage current flows. However, since the electrostatic discharge circuit ESDC2 of the present disclosure does not include the resistor R, the leakage current may be prevented from flowing when the display device 1000 is driven. Accordingly, a decrease in power consumption of the display device 1000 may be prevented.

In addition, since the electrostatic discharge circuit ESDC2 of the present disclosure does not include the resistor R, the type of wiring that may be used as the signal line SL may increase.

Specifically, the conventional electrostatic discharge circuit ESDC1 disclosed in FIG. 3 may use at least one of the data line DL, the gate start signal line, and the gate clock signal line as the signal line SL. That is, the conventional electrostatic discharge circuit ESDC1 disclosed in FIG. 3 may use a wiring for applying an AC voltage as the signal line SL, not a DC voltage.

When the conventional electrostatic discharge circuit ESDC1 uses a wiring for applying the DC voltage to the signal line SL, the resistor R disposed in the conventional electrostatic discharge circuit ESDC1 may be used as the path through which the leakage current flows. In this case, a problem of increasing power consumption of the display device 1000 may occur. Accordingly, the conventional electrostatic discharge circuit ESDC1 may use only a wiring for applying the AC voltage as the signal line SL.

On the other hand, as described above, the electrostatic discharge circuit ESDC2 of the present disclosure may omit the configuration of the resistor R. Therefore, even if the electrostatic discharge circuit ESDC2 of the present disclosure uses a wiring for applying the DC voltage as the signal line SL, a problem in which power consumption of the display device 1000 increases due to the leakage current may not occur.

Like the conventional electrostatic discharge circuit ESDC1 disclosed in FIG. 3, the electrostatic discharge circuit ESDC2 of the present disclosure may use a wiring for applying the AC voltage to the signal line SL. For example, the electrostatic discharge circuit ESDC2 of the present disclosure may use at least one of the data line DL, the gate start signal line, and the gate clock signal line as the signal line SL, or use a wiring branched from at least one of the data line DL, the gate start signal line, and the gate clock signal line.

Additionally, the electrostatic discharge circuit ESDC2 of the present disclosure may use a wiring for applying the DC voltage to the signal line SL. For example, the electrostatic discharge circuit ESDC2 of the present disclosure may use the high-potential voltage line EVDDL or the low-potential voltage line EVSSL as the signal line SL, or use a wiring branched from any one of the high-potential voltage line EVDDL and the low-potential voltage line EVSSL.

In addition, the electrostatic discharge circuit ESDC2 of the present disclosure may use a wiring for applying various AC voltages or DC voltages for driving the display device 1000 as the signal line SL.

For example, when the plurality of pixels P of the present disclosure further include an initialization voltage line to receive an initialization voltage for initializing a specific electrode of the driving transistor DT or the switching transistor ST, the electrostatic discharge circuit ESDC2 of the present disclosure may use the initialization voltage line or a wiring branched from the initialization voltage line as the signal line SL.

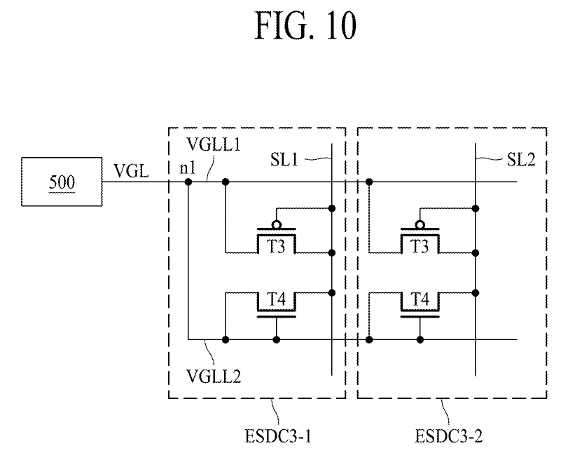

In FIG. 7, only one electrostatic discharge circuit ESDC2 is disclosed, but the present disclosure is not limited thereto. FIG. 10 is a circuit diagram of an electrostatic discharge circuit according to one or more other embodiments of the present disclosure. Referring to FIG. 10, a first electrostatic discharge circuit ESDC3-1 and a second electrostatic discharge circuit ESDC3-2 may be continuously disposed.

A drain electrode of the third transistor T3 of the first electrostatic discharge circuit ESDC3-1 and a drain electrode of the third transistor T3 of the second electrostatic discharge circuit ESDC3-2 may be electrically connected to each other. The drain electrode of the third transistor T3 of the first electrostatic discharge circuit ESDC3-1 and the drain electrode of the third transistor T3 of the second electrostatic discharge circuit ESDC3-2 may be connected to a first gate low voltage line VGLL1.

The drain electrode of the third transistor T3 of the first electrostatic discharge circuit ESDC3-1 and the drain electrode of the third transistor T3 of the second electrostatic discharge circuit ESDC3-2 may be connected to the same node by the first gate low voltage line VGLL1.

The third transistor T3 of the first electrostatic discharge circuit ESDC3-1 and the third transistor T3 of the second electrostatic discharge circuit ESDC3-2 may be connected to the same first gate low voltage line VGLL1.

A gate electrode of the fourth transistor T4 of the first electrostatic discharge circuit ESDC3-1, a source electrode of the fourth transistor T4 of the first electrostatic discharge circuit ESDC3-1, a gate electrode of the fourth transistor T4 of the second electrostatic discharge circuit ESDC3-2, and a source electrode of the fourth transistor T4 of the second electrostatic discharge circuit ESDC3-2 may be electrically connected to each other. The gate electrode of the fourth transistor T4 of the first electrostatic discharge circuit ESDC3-1, the source electrode of the fourth transistor T4 of the first electrostatic discharge circuit ESDC3-1, the gate electrode of the fourth transistor T4 of the second electrostatic discharge circuit ESDC3-2, and the source electrode of the fourth transistor T4 of the second electrostatic discharge circuit ESDC3-2 may be connected to the second gate low voltage line VGLL2.

The gate electrode of the fourth transistor T4 of the first electrostatic discharge circuit ESDC3-1, the source electrode of the fourth transistor T4 of the first electrostatic discharge circuit ESDC3-1, the gate electrode of the fourth transistor T4 of the second electrostatic discharge circuit ESDC3-2, and the source electrode of the fourth transistor T4 of the second electrostatic discharge circuit ESDC3-2 may be connected to the same node by the second gate low voltage line VGLL2.

The fourth transistor T4 of the first electrostatic discharge circuit ESDC3-1 and the fourth transistor T4 of the second electrostatic discharge circuit ESDC3-2 may be connected to the same second gate low voltage line VGLL2. The second gate low voltage line VGLL2 may be a wiring branched from a first node n1 of the first gate low voltage line VGLL1.

The gate electrode and the source electrode of the third transistor T3 of the first electrostatic discharge circuit ESDC3-1 may be connected to a first signal line SL1, and the gate electrode and the source electrode of the third transistor T3 of the second electrostatic discharge circuit ESDC3-2 may be connected to a second signal line SL2.

The drain electrode of the fourth transistor T4 of the first electrostatic discharge circuit ESDC3-1 may be connected to the first signal line SL1, and the drain electrode of the fourth transistor T4 of the second electrostatic discharge circuit ESDC3-2 may be connected to the second signal line SL2. That is, the first electrostatic discharge circuit ESDC3-1 and the second electrostatic discharge circuit ESDC3-2 may be connected to different signal lines SL.

The first signal line SL1 and the second signal line SL2 may not be connected to each other.

When a static electricity is introduced through the first signal line SL1, the static electricity may be discharged through the first electrostatic discharge circuit ESDC3-1. In addition, when a static electricity is introduced through the second signal line SL2, the static electricity may be discharged through the second electrostatic discharge circuit ESDC3-2.

That is, since the first electrostatic discharge circuit ESDC3-1 and the second electrostatic discharge circuit ESDC3-2 are disposed continuously, the number of signal lines SL through which the static electricity may be introduced is increased, so that the static electricity introduced into the display panel 100 may be released more smoothly.

It will be apparent to those skilled in the art that the present disclosure described above is not limited by the above-described embodiments and the accompanying drawings and that various substitutions, modifications and variations can be made in the present disclosure without departing from the technical idea or scope of the disclosures. Consequently, the scope of the present disclosure is defined by the accompanying claims and it is intended that all variations or modifications derived from the meaning, scope and equivalent concept of the claims fall within the scope of the present disclosure

What is claimed is:

1. A display device, comprising:
a display panel including a plurality of pixels and an electrostatic discharge circuit unit; and
a plurality of electrostatic discharge circuits disposed in the electrostatic discharge circuit unit,
wherein each of the plurality of electrostatic discharge circuits includes a first transistor and a second transistor,
wherein the first transistor is a P-type MOSFET,
wherein the second transistor is an N-type MOSFET,
wherein each of the first transistor and the second transistor includes a gate electrode, a source electrode, and a drain electrode, and
wherein the gate electrode of the first transistor, the source electrode of the first transistor, and the drain electrode of the second transistor are electrically connected to each other.

2. The display device of claim 1, wherein each of the plurality of electrostatic discharge circuits further includes a signal line, and
wherein the signal line is connected to the gate electrode of the first transistor, the source electrode of the first transistor, and the drain electrode of the second transistor.

3. The display device of claim 2, further comprising a data driver configured to apply a data voltage to the plurality of pixels through a plurality of data lines, and
wherein the signal line is any one of the plurality of data lines or a wiring branched from any one of the plurality of data lines.

4. The display device of claim 2, further comprising:
a gate driver configured to apply a gate signal to the plurality of pixels; and
a timing controller configured to apply a gate start signal to the gate driver through a gate start signal line, and
wherein the signal line is the gate start signal line or a wiring branched from the gate start signal line.

5. The display device of claim 1, wherein the drain electrode of the first transistor, the gate electrode of the second transistor, and the source electrode of the second transistor are electrically connected to each other.

6. The display device of claim 5, wherein each of the plurality of electrostatic discharge circuits further includes a power line, and
wherein the power line is connected to the drain electrode of the first transistor, the gate electrode of the second transistor, and the source electrode of the second transistor.

7. The display device of claim 6, further comprising:
a gate driver configured to apply a gate signal to the plurality of pixels; and
a power supply unit configured to apply a gate low voltage to the gate driver, and
wherein the power line receives the gate low voltage.

8. The display device of claim 7, wherein the power line further includes a first line receiving a first voltage from the power supply unit and a second line branched from a first node of the first line,
wherein the first line is connected to the drain electrode of the first transistor, and
wherein the second line is connected to the gate electrode of the second transistor and the source electrode of the second transistor.

9. The display device of claim 1, wherein the plurality of electrostatic discharge circuits include a first electrostatic discharge circuit and a second electrostatic discharge circuit,
wherein the first electrostatic discharge circuit includes a first signal line, and the second electrostatic discharge circuit includes a second signal line,
wherein in the first electrostatic discharge circuit, the first signal line is connected to the gate electrode of the first transistor, the source electrode of the first transistor, and the drain electrode of the second transistor, and
wherein in the second electrostatic discharge circuit, the second signal line is connected to the gate electrode of the first transistor, the source electrode of the first transistor, and the drain electrode of the second transistor.

10. The display device of claim 9, wherein the first signal line and the second signal line are not connected.

11. The display device of claim 9, wherein the drain electrode of the first transistor of the first electrostatic discharge circuit is electrically connected to the drain electrode of the first transistor of the second electrostatic discharge circuit, and
wherein the gate electrode of the second transistor of the first electrostatic discharge circuit and the source electrode of the second transistor of the first electrostatic discharge circuit are electrically connected to the gate electrode of the second transistor of the second electrostatic discharge circuit and the source electrode of the second transistor of the second electrostatic discharge circuit.

12. The display device of claim 11, further comprising:
a gate driver configured to apply a gate signal to the plurality of pixels; and
a power supply unit configured to apply a gate low voltage to the gate driver,
wherein the first electrostatic discharge circuit includes a first line receiving the gate low voltage and a second line branched from the first line,
wherein in the first electrostatic discharge circuit, the first line is connected to the drain electrode of the first transistor, and
wherein in the first electrostatic discharge circuit, the second line is connected to the gate electrode of the second transistor and the source electrode of the second transistor.

13. The display device of claim 12, wherein the first line and the second line extend to the second electrostatic discharge circuit,
wherein in the second electrostatic discharge circuit, the first line is connected to the drain electrode of the first transistor, and
wherein in the second electrostatic discharge circuit, the second line is connected to the gate electrode of the second transistor and the source electrode of the second transistor.

14. A display device, comprising:
a display panel including a plurality of pixels and an electrostatic discharge circuit;
a gate driver generating, using a power voltage, a scan signal applied to a pixel of the plurality of pixels for scanning the pixel;
a power line through which the power voltage is supplied to the electrostatic discharge circuit; and
a signal line through which a first signal for driving the pixel is applied to the pixel or through which a second signal for controlling the gate driver is applied to the gate driver,
wherein the electrostatic discharge circuit includes:
a first transistor of a first type that is turned on in response to a first logic signal, and
a second transistor of a second type that is turned on in response to a second logic signal opposite to the first logic signal,
wherein a gate electrode of the first transistor, a source electrode of the first transistor, and a drain electrode of the second transistor are electrically connected to the signal line, and
wherein a drain electrode of the first transistor, a gate electrode of the second transistor, and a source electrode of the second transistor are electrically connected to the power line.

15. The display device of claim 14, further comprising a data driver configured to apply a data voltage to a data line connected to the pixel, and
wherein the signal line is the data line or a wiring branched from the data line through which the first signal comprising the data voltage is applied to the pixel.

16. The display device of claim 14, further comprising a timing controller configured to apply a gate start signal to the gate driver through a gate start signal line,
wherein the gate start signal is a signal that controls a timing of the scan signal, and
wherein the signal line is the gate start signal line or a wiring branched from the gate start signal line through which the first signal comprising the gate start signal is applied to the gate driver.

17. The display device of claim 14, further comprising a timing controller configured to apply a gate clock signal to the gate driver through a gate clock signal line,
wherein the gate clock signal is a signal that shifts a gate start signal applied to the gate driver for controlling a timing of the scan signal, and
wherein the signal line is the gate clock signal line or a wiring branched from the gate clock signal line through which the second signal comprising the gate clock signal is applied to the gate driver.

18. The display device of claim 14, wherein the first transistor is a p-type MOSFET transistor, and
wherein the second transistor is an n-type MOSFET transistor.

19. The display device of claim 14, further comprising:
a second electrostatic discharge circuit including a third transistor of the first type and a fourth transistor of the second type; and
a second signal line through which a third signal is applied to a second pixel of the plurality of pixels for driving the second pixel or through which a fourth signal for controlling the gate driver is applied to the gate driver,
wherein a gate electrode of the third transistor, a source electrode of the fourth transistor, and a drain electrode of the fourth transistor are electrically connected to the second signal line, and
wherein a drain electrode of the third transistor, a gate electrode of the fourth transistor, and a source electrode of the fourth transistor are electrically connected to the power line.

20. The display device of claim 19, further comprising a data driver configured to:
apply a first data voltage to a first data line connected to the pixel, and
apply a second data voltage to a second data line connected to the second pixel,
wherein the signal line is the first data line or a wiring branched from the first data line through which the first signal comprising the first data voltage is applied to the pixel, and
wherein the second signal line is the second data line or a wiring branched from the second data line through which the third signal comprising the second data voltage is applied to the second pixel.
